(19) United States
(12) Patent Application Publication
(10) Pub. No.: US 2024/0330315 A1
(43) Pub. Date: Oct. 3, 2024

(54) EVENT BASED SOURCE REPLICATION ARCHITECTURE

(71) Applicant: VMware, Inc., Palo Alto, CA (US)

(72) Inventors: Subrahmanya Kumar Giliyaru, Bangalore (IN); Subhashish Pattajoshi, Bangalore (IN); Shridhara Rangajuru, Bangalore (IN); Manish Kumar, Atlanta, GA (US); Suman Rani, Bangalore (IN); Devdutt Rajaram, Bangalore (IN); Abhinav Jain, Bangalore (IN)

(21) Appl. No.: 18/130,277

(22) Filed: Apr. 3, 2023

(51) Int. Cl. G06F 16/27; G06F 16/23; G06F 16/28

(52) U.S. Cl. CPC G06F 16/27; G06F 16/2358; G06F 16/288

(57) ABSTRACT

Examples of an extensible event based source replication architecture for management services are described. In some examples, an orchestrator service identifies management data source services and a particular management data source service maintains a corresponding database. Network-service-specific replication pipelines are generated for a set of network services. A particular replication pipeline is registered in association with one or more tenant identifiers and one or more entity identifiers. Event data is received as a number of database update messages are received. A subset of the event data is identified according to the entity identifier and the tenant identifier and is replicated into the particular replication pipeline for a particular network service.

### BACKGROUND

Information technology administrators can struggle to keep up with the evolving landscape of services that are added to and removed from management level services. The resulting information technology problems can be of many different types. Some are related to a requirement to update connections between various interrelated internal services, while others are due to issues on end-user devices, and still others are related to providing information to external services.

Despite testing prior to the deployment and modification of management services and internal data sources, new incompatibilities can be discovered after the deployment. This can require development of many incompatibility corrections for a management service and its associated systems in response to every data source modification. Furthermore, any external service that the enterprise or management service decides to integrate can also require development of incompatibility corrections. This can have a large impact including financial losses and time losses to the enterprise and the management service alike. As a result, there is a need for technologies that can enable an extensible architecture for management subservices and other management service data sources.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates an example networked environment that includes components that provide an extensible architecture for event based source replication, according to various examples described herein.

FIG. 2 illustrates an example of the operation of the networked environment to provide an extensible architecture for event based source replication, according to various examples described herein.

FIG. 3 illustrates another example of the operation of the networked environment to provide an extensible architecture for event based source replication, according to various examples described herein.

FIG. 4 illustrates a flowchart performed by components of the networked environment to provide an extensible architecture for event based source replication, according to various examples described herein.

### DETAILED DESCRIPTION

The present disclosure relates to providing an extensible event based source replication architecture for management services. As noted above, information technology administrators in an enterprise can struggle to keep up with the large number of changes to management service data sources. These changes can require manual development of incompatibility corrections for a management service and its associated systems. External services can also require development of incompatibility corrections. This can have a large impact including financial losses and time losses to the enterprise and the management service alike.

The present disclosure describes mechanisms that can enable an extensible architecture by providing event based source replication for data sources such as microservices used by a management service. For example, a management service can be updated from a monolith type service to multiple management microservices. In various examples, the information provided to enterprise users and external services integrated with an enterprise's solution can remain the same or can be updated by such a change. Each management microservice can be considered a data source service that maintains its own isolated or otherwise individualized datastore. These enterprise or management databases can be provided using the same hardware or separate hardware relative to one another, but can be logically separated. External services can have access to endpoint management service data. In order to provide external services with consistent extensible access to the many records associated with each data source service, the present disclosure can provide an updated and extensible set of data source services that utilize a public schema, a messaging platform, and an orchestrator.

Generally, the data source services provide the ability to publish their current state and change in state as events according to a public schema that abstracts the data source services from the type of information provided. The public schema can be considered an agreed upon schema established between management (e.g., endpoint management) microservices and external components. This includes entity representation, event representation, and over the wire serialization support. The data source services in the system can publish events in public schema representation. Since the external services can receive events of a particular type, rather than events from a particular service, the public schema and overall architecture can abstract the internal management data source microservices from the event data. One or more messaging platforms such as Apache Kafka, or another event messaging platform, can provide the ability for the external components to asynchronously observe and consume events published by management data source services. The orchestrator can support onboarding of external components and data source services to one or more replication pipeline. The orchestrator can also streamline events from across data source services to external components through the messaging platform.

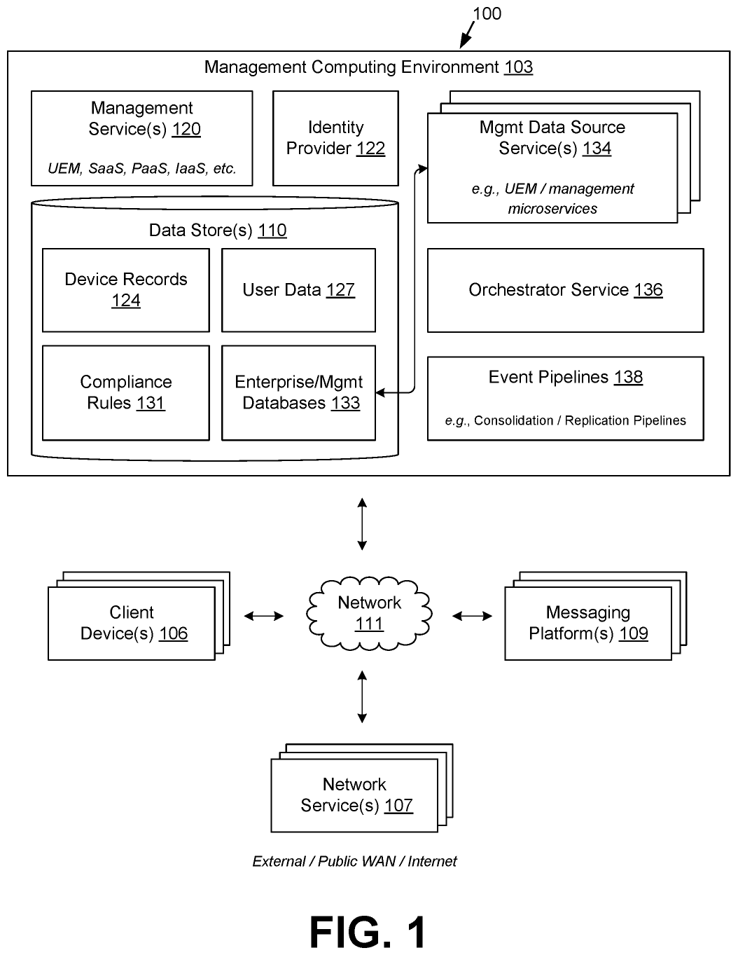

FIG. 1 illustrates an example networked environment 100 that includes components that troubleshoot enterprise information technology problems according to various examples described herein. The networked environment 100 includes a management computing environment 103, several client devices 106, network services 107, and messaging platforms 109 in communication through a network 111.

The management computing environment 103 can be embodied as one or more computers, computing devices, or computing systems. In certain embodiments, the management computing environment 103 can include one or more computing devices arranged, for example, in one or more server or computer banks. The computing device or devices can be located at a single installation site or distributed among different geographical locations. The management computing environment 103 can include a plurality of computing devices that together embody a hosted computing resource, a grid computing resource, or other distributed computing arrangements. In some cases, the management computing environment 103 can be embodied as an elastic computing resource where an allotted capacity of processing, network, storage, or other computing-related resources varies over time. As further described below, the management computing environment 103 can also be embodied, in part, as certain functional or logical (e.g., computer-readable instruction) elements or modules as described herein.

The management computing environment 103 can operate as an environment for mobile device management and a unified endpoint management (UEM) platform that can manage the client devices 106, and other devices and endpoints. In that context, the management computing environment 103 includes a data store 110. The management computing environment 103 can also execute a management service 120 and an identity provider 122. The data store 110 can include areas in memory for the storage of device records 124 corresponding to client devices 106 that are registered and enrolled with the management service 120, as well as user data 127, compliance rules 131, and a number of enterprise-specific or agnostic management databases 133.

The management computing environment 103 can also include a number of management data source services 134. Each management data source service 134 can be associated with a corresponding management database 133. The management computing environment 103 can also include an orchestrator service 136 as well as event pipelines 138. The event pipelines 138 can include source and replication pipelines that can respectively aggregate and/or replicate event messages from the management data source services 134. The orchestrator service 136 can work in concert with these event pipelines 138 and the messaging platforms 109 to expose event data to external network services 107.

The device records 124 can include a compliance status, enrollment data, device identifiers. The device records 124 can include or be associated with particular compliance rules 131 of a number of different compliance policies, user data 127 associated with user accounts that use the client device 106, among other types of data. The enrollment data can indicate whether a particular client device 106 is enrolled with the management service 120. Enrollment can indicate that a management policy is enforced on, and/or the management agent is installed to, the client device 106.

User data 127 represents information about users who have user accounts in the enterprise. These users can also have one or more client devices 106 that are enrolled as managed devices with the management service 120. User data 127 can include authentication data, and information about third party services with which the user is assigned an account. Device identifiers can correspond to a unique device identifier assigned to a client device 106 upon enrollment. A device identifier can alternatively refer to a manufacturer-assigned device identifier such as a serial number. A device identifier can uniquely identify the client device 106 among other enrolled or monitored client devices 106.

Compliance rules 131 can include management rules, security rules, and other configuration data for execution by and/or enforcement on the client device 106. This can include management, security, and other configuration profiles that can include and enforce VPN certificates, Wi-Fi profiles, and email profiles. In that context, during or after enrollment, the management service 120 can generate a set of management rules, security rules, and configuration data for the client device 106 and transfer those policies, rules, and data to the client device 106 for reference by the operating system and certain applications executing on the client device 106.

Management data source services 134 can track and maintain management databases 133 to provide subsets of the items described as included in the device records 124, the user data 127, and the compliance rules 131. For example, a management data source service 134 can track and maintain a management database 133 of compliance statuses in association with device identifiers, while another can include enrollment data, and another can provide compliance rules 131. Alternatively, a single management data source service 134 can provide compliance statuses, enrollment data, compliance rules 131, and user data 127, among other arrangements.

The management services 120 can operate as a UEM platform that can manage client devices 106 that are enrolled as managed devices with the management service 120. The management services 120 can also include virtualization services that provide software as a service, infrastructure as a service, and platform as a service. This can include providing virtual desktop services, virtual applications and appliances, and other virtualization services for enrolled client devices 106.

The client devices 106 are representative of one or more client devices 106. Each client device 106 can be embodied as any computing device, processing circuit, or processor based device or system, including those in the form of a desktop computer, a laptop computer, a tablet computer, a personal digital assistant, a cellular telephone, a wearable computing device, or a set-top box, among other example computing devices and systems. Depending upon its primary purpose or function, for example, the client devices 106 can include various peripheral devices or components. The peripheral devices can include input or communication devices or modules, such as keyboards, keypads, touch pads, touch screens, microphones, cameras, wireless communications modules (e.g., infra-red, WI-FI, or BLUETOOTH®), buttons, switches, or sensors. The peripheral devices can also include a display, indicator lights, speakers, global positioning system (GPS) circuitry, accelerometers, gyroscopes, or other peripheral devices depending upon the primary purpose or function of the client devices 106.

An example client device 106 can be enrolled by the management service 120 for device management. A management agent can be installed on a client device 106 to locally manage the device on behalf of the remotely executed management service 120. The management agent can be installed with elevated privileges or be effectuated through operating system APIs to manage the client device 106 on behalf of the management service 120. The management agent can have the authority to manage data on the client device 106, install, remove, or disable certain applications, or install configuration profiles, such as VPN certificates, Wi-Fi profiles, email profiles, etc. The management agent can also have the authority to enable or disable certain hardware features of the client device 106 in certain instances. For example, the management agent can also place the device into different hardware modes, such as airplane mode, silent mode, do-not-disturb mode, or other modes supported by the client device 106.

The client applications can include applications that correspond to various platform types and delivery types. A particular client application can have both a platform type and a delivery type. For example, client applications can include application variants corresponding to certain platforms such as ANDROID applications, APPLE IOS applications, APPLE MACOS applications, WINDOWS applications. Client applications can include application variants corresponding to delivery types including installed applications, RDSH applications, VDI applications, thin wrapped executable applications, application volumes applications, and others.

The device records can include device data such as timestamped device telemetry such as device events, performance metrics, installed applications, active applications, operating system type and version, device model identifier, and so on. An active application can refer to an application that is executed or an application that is both executed and user-accessed, shown on screen, or otherwise active. Device telemetry can include operating system crashes, CPU or processor usage, memory (e.g., random access memory or other access memory) usage, device boot time, device shut down time, application hangs corresponding to temporary non-responsiveness, application crashes, increase/decrease of application usage, failed logins, failed application launch, application launch time, among others.

As part of the enrollment process, the management service 120 and/or management agent can be registered as a device administrator of the client device 106, permitting the management service 120 and/or management agent to manage certain operating aspects of the client device 106. The management agent can operate at a privileged level associated with a system account of the operating system. The management service 120 can remotely configure the client device 106 by interacting with the management agent. The management service 120 can also transfer various software components to the client device 106, and those software components can be installed and/or configured on the client device 106 at the direction of the management agent. Such software components can include, for example, applications, resources, libraries, drivers, device configurations, or other related components.

The management service 120 can also transfer various management policies, configuration data, and other compliance rules 131 for enforcement on the client device 106, and those policies, rules, and data can be stored on the client device 106 by the management agent. The management service 120 can then instruct the management agent and the operating system of the client device 106 to enforce the management policies, compliance rules 131, and configuration data stored on the client device 106. The operating system can include Windows®, Linux®, Apple®, or another operating system. The operating system can be utilized to enforce the compliance rules 131. A compliance status can identify which compliance rules 131 or policies a client device 106 or a user account linked to the client device 106 has violated. For example, the client device 106 may have been taken outside of a specified geofence defined for the client device 106.

The management service 120 can enroll several client devices 106 for mobile device management services. To begin enrollment, the management service 120 can identify and authenticate one of the client devices 106 and store data related to the client device 106 for later reference. In some cases, the management service 120 (or a management agent, an application, or a component executing on the client device 106) can also be registered as a device administrator (at least in part) of the client device 106, permitting the management service 120 to configure and manage certain operating aspects of the client device 106.

Once the client device 106 is enrolled for device management by the management service 120, the management service 120 can direct the installation of various software components and client applications on the client device 106. The software components can be configured on the client device 106 at the direction of the management service 120. Such software components can include, for example, applications, resources, libraries, and other related components. Client application installation can refer to standard installation of an application corresponding to a platform of the client device, or installation of components and authentication data to access a particular client application corresponding to a specified virtualization or access type such as an installed application, RDSH application, VDI applications, thin wrapped executable applications, or application volumes applications.

The management service 120 can also provide a management console as an engine and console interface for device management of the client devices 106. An information technology administrator or user, for example, can view, administer, and update the management policies, compliance rules, and configuration data on the client devices 106 using the management console. The policies, rules, and configuration data can be collectively administered for several of the client devices 106 by organizing the client devices 106 into several different groups or categories of devices, according to organizational or other factors or considerations.

The identity provider 122 can provide single sign-on or identity management capabilities for an enterprise. The identity provider 122 can allow users to authenticate his or her identity to obtain an authentication token that can be provided to a network service 107 or analytics platform 104. The identity provider 122 can utilize OAuth, security assertion mark-up language (SAML), or other single sign-on methodologies. The identity provider 122 and management service 120 can communicate so that the management service 120 can revoke or authorize access to various services for users in the enterprise based on the status of a client device 106 assigned to the user. The identity provider 122 can also rely on user data 127 in the data store 110. In some examples, the identity provider 122 can rely upon a separate source of user data in a separate data store.

Each of the network services 107 can be embodied as one or more computers, computing devices, or computing systems. Like the management computing environment 103, the network service 107 can include one or more computing devices arranged, for example, in one or more server or computer banks. The computing device or devices can be located at a single installation site or distributed among different geographical locations. The network service 107 can include a plurality of computing devices that together embody a hosted computing resource, a grid computing resource, or another distributed computing arrangement. The network service 107 can also be embodied, in part, as certain functional or logical (e.g., computer-readable instruction) elements or modules as described herein.

The network services 107 can include first party and third party services provided by an enterprise to its users. A network service 107 can federate its authentication for users of the enterprise to the identity provider 122. A network service 107 can be a cloud-based storage service, recovery key escrow service, or another system for which the identity provider 122 can authenticate access by users of the enterprise. A network service 107 can be accessible over the Internet or another public WAN. The network services 107 can be external services relative to the management computing environment 103, the management service 120, and the management data source services 134, the orchestrator service 136, and other microservices of the management service 120. The network services 107 can be accessible over a public WAN such as the Internet. In some examples, the management computing environment 103 includes a private LAN or private WAN, and the network services 107 are external to the private LAN or private WAN of the management computing environment 103.

The network services 107 can include endpoint security systems, such as security information, event management (SIEM) systems, and analytics platforms among other services. The client devices 106 can communicate with the network services 107, and the network services 107 can access device events and other event data provided using the management data source services 134.

The network 111 can include the Internet, intranets, extranets, wide area networks (WANs), local area networks (LANs), wired networks, wireless networks, cable networks, satellite networks, other suitable networks, or any combinations thereof. As one example, the management computing environment 103 and the client devices 106 can be respectively coupled to one or more public or private LANs or WANs and, in turn, to the Internet for communication of data among each other. Although not shown in FIG. 1, the network 111 can also include communicative connections to any number and type of network hosts or devices, such as website servers, file servers, cloud computing resources, databases, data stores, or any other network or computing architectures.

In the networked environment 100, the management computing environment 103, the network service 107, and the client devices 106 can communicate data among each other over the network 111 using one or more network transfer protocols or interconnect frameworks, such as hypertext transfer protocol (HTTP), simple object access protocol (SOAP), representational state transfer (REST), real-time transport protocol (RTP), real time streaming protocol (RTSP), real time messaging protocol (RTMP), user datagram protocol (UDP), internet protocol (IP), transmission control protocol (TCP), other protocols and interconnect frameworks, and combinations thereof.

The orchestrator service 136 can receive and aggregate event messages from all of the management data source services 134, and can organize and replicate the messages for consumption by the external network services 107 according to event types, entity identifiers, tenant identifiers, and device identifiers. That is, the external network services 107 can request access to event data that is tagged using a particular set of entity identifiers and a particular set of tenant identifiers. The orchestrator service 136 can receive all events from all management data source services 134, and can generate a replication pipeline that includes a subset of the event data that is requested by (and authorized for) an external network service 107. The orchestrator service 136 can confirm authorization for entity identifiers using entity-specific certificates, tokens, and other authentication data. The orchestrator service 136 can confirm authorization for tenant identifiers using tenant-specific certificates, tokens, and other authentication data. Tenants can refer to enterprises that employ or utilize the management service 120 for UEM, software as a service, platform as a service, infrastructure as a service, and other services.

The orchestrator service 136 can receive data source registration requests for a new management data source service 134 and can set up a source pipeline that receives all messages including event data generated by that management data source service 134. The list of management data source services 134 can be opaque to the network services 107. As a result, the external network services 107 can register to receive event data using a particular set of entity identifiers and a particular set of tenant identifiers. An entity identifier can represent a class or type of data of interest to the network service 107.

The orchestrator service 136 can receive requests from a new external network service 107 to subscribe to or otherwise receive event data that is tagged using a particular set of entity identifiers and a particular set of tenant identifiers. The orchestrator service 136 can then modify the event pipelines 138 to provide the requested data. The event messages from a particular management data source service 134 can include event data that represents changes or updates to one or more management databases 133.

The messaging platforms 109 can include platforms such as Apache Kafka, RabbitMQ, Pulsar, and other event messaging platforms. The orchestrator service 136 can utilize and configure the event pipelines 138 to provide the requested event data to the network services 107 through the messaging platforms 109. The orchestrator service 136 can also transmit commands to the messaging platforms 109 to provide the event data to the network services 107.

The public schema used by the components of the networked environment 100 can also aid the efficient replication of event data. Management data source services 134 can publish or provide schema-compliant event data that is limited to updates or changes to the data in its corresponding management database 133, unless a snapshot request is received. A snapshot request can cause the orchestrator service 136 to generate and transmit all existing event data that corresponds to a particular tenant identifier and/or entity identifier for all management databases 133. The orchestrator service 136 can provide this snapshot data, for example, in response to a new network service 107 that is registering with the orchestration service 136 in association with a particular tenant identifier and/or entity identifier.

The public schema can use JavaScript Object Notation (JSON), extensible markup language (XML), or another data interchange or markup language format. The public schema can include a number of schema definitions, including event schema definitions. The public schema can define multiple fields which are organized in a JSON array or another type of data structure. A field can identify a field name and a field type. The type can refer to an integer, or something complex, like a record type. Records can include (C#), Java, or other types of classes, and protobuf or another protocol for data exchange.

The event schema definitions can include schema definitions to create events, update events, and delete events. The create event public schema definition can include a set of parameters and values that are used to describe the creation of a new record in a management database 133. The update event public schema definition can include a set of parameters and values that are used to describe an update to an existing record in a management database 133. The delete event public schema definition can include a set of parameters and values that are used to describe the deletion of a record from a management database 133. Each event schema definition can specify a set of event parameters, and a set of fields. A particular event that uses the event schema definition (e.g., create event, update event, delete event, etc.) can include the set of event parameters and fields and a value for at least a subset of the set of event parameters and fields. Generally, the event schema definitions can include event parameters including namespace, event name/type/identifier, data type, event description, version, and event type-specific fields.

The event type-specific fields for a create event can include a record type identifier field, an event identifier field indicating a create event, a tenant identifier field, and an entity identifier field. The record type identifier field can include a name parameter for a record type identifier value (e.g., user identifier, device identifier, application identifier, service identifier, or other identifier associated with corresponding record types). The event type-specific fields can include a description that explains that the device identifier is a unique device identifier (UDID) or universally unique identifier (UUID) defined by the management service 120, a data type of the device identifier (e.g., string, integer, float), and a logical type such as “UDID” or “UUID.” The tenant identifier field can include a name parameter for a tenant identifier value, a description that explains that the device identifier is a UUID defined by the management service 120, a data type of the tenant identifier, and a logical type such as “UUID.” The entity identifier field can include a name parameter for an entity identifier value, a description that explains that the entity identifier is a UUID defined by the management service 120, a data type of the entity identifier, and a logical type such as “UUID.” A create event can include a specification of all known or tracked attributes of a device, user, application, service, or other record. Each attribute can be listed in association with a data type, a textual description, and an attribute identifier.

The event type-specific fields for an update event can include a record-type indicating identifier field, an event identifier field indicating an update event, a tenant identifier field, an entity identifier field, and can define a change array that is limited to a set of changes to the record, rather than redefining each and every parameter. This can save data and increase data efficiency and decrease energy expenditure. The change array can specify sub-events that can be performed against the attributes listed. The sub-events can include create attribute, update attribute, delete attribute, and replace attribute. The change array can conform to the attribute change schema definition, which can specify attribute reference identifier and change sub-event type as fields. Create attribute implements a change from null to some valid value. Delete attribute implements a change from null to some valid value. Replace attribute implements a change from one valid value to another valid value. Update attribute refers to a special case which is applied to implement changes of values within an array.

The event type-specific fields for a delete event can include a record-type indicating identifier field, an event identifier field indicating a delete event, a tenant identifier field, and an entity identifier field. Since the record is being deleted, the attributes and additional data is not provided. This can save data and increase data efficiency and decrease energy expenditure.

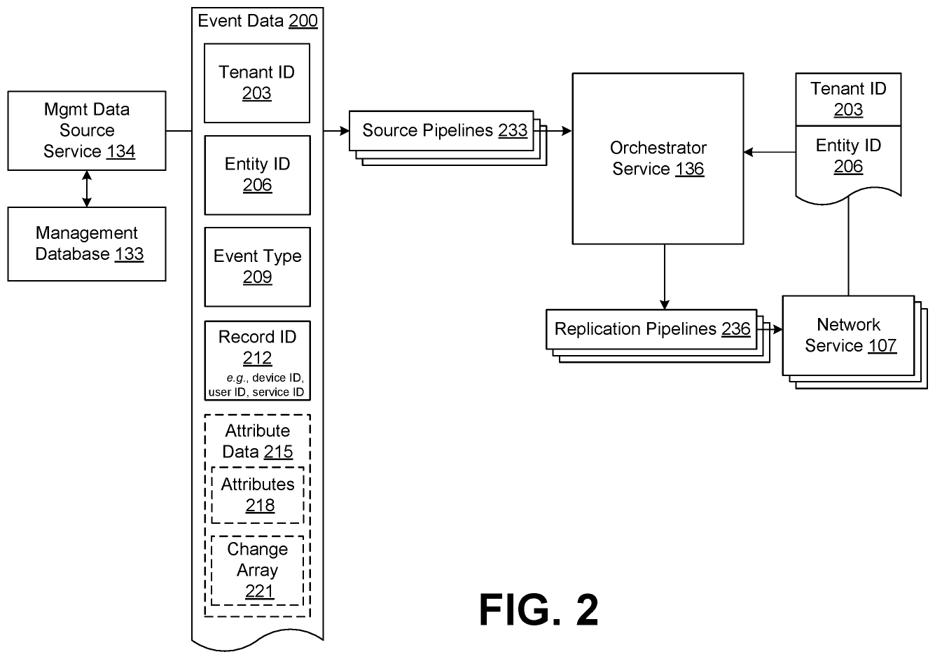

FIG. 2 shows an example of how the components of the networked environment 100 can interact to provide an extensible architecture for replication of event data generated by the management data source services 134. Generally, this example provides an example of how a management data source service 134 provides event data 200 to a source pipeline 233, and the orchestrator service 136 replicates this to the appropriate replication pipelines 236 for consumption by network services 107.

The management data source service 134 can be associated with the management database 133. The management data source service 134 can identify an event that changes a record in the management database 133. The update can include creation of a new record, a change to an attribute of a record, or a deletion of a record in the management database 133. In some examples, the management data source service 134 can perform the update to the management database 133 based on information received from an agent on the client device 106, or the management data source service 134 can identify the change once another logical entity of the management service 120 performs the update.

The management data source service 134 can be configured to generate event data 200 for the event according to the public schema of the extensible architecture for event data replication. The event data 200 can specify a tenant identifier 203, an entity identifier 206, an event type 209, a record identifier 212, and attribute data 215. The tenant identifier 203 can include a universally unique identifier specified by the management service 120 for a particular tenant or enterprise associated with the record that is subject of the event data 200. The entity identifier 206 can be a universally unique identifier that provides an abstraction that the network service 107 can request so that it can consume or receive a specific subset of event data 200 from the various management databases 133 of the management service 120.

The management data source service 134 can generate the event type 209 to correspond to the type of update that was performed to the management database 133. For example, the event type 209 can specify a create event, an update event, a delete event, or another type of event. The record identifier 212 can include a universally unique identifier specified by the management service 120 for a particular record that is subject of the event data 200. The record identifier can refer to a device identifier such as a UDID, a user identifier of a user of the management service 120, a service identifier of a service provided by the management service 120, an application identifier of an application provided by the management service 120, and so on.

The management data source service 134 can include (and exclude) attribute data 215 based on the event type 202. For example, a create record event can include attribute data 215 corresponding to a set of attributes 218 that define the whole device, user, service, application, or other record. An update record event can include attribute data 215 corresponding to a change array 221 that defines and is limited to a subset of attributes 218 that are changed for the device, user, service, application, or other record. A delete record event can omit or lack attribute data 215. This reduces energy usage and data transfer efficiency of the system. Attribute data 215 can generally be provided as a value of a field, which can be logically associated with a textual description and a data type such as bits, bytes, string, integer, and so on.

A network service 107 can transmit an external service registration request to receive a specified subset of the event data 200. The external service registration request can specify a tenant identifier 203 and an entity identifier 206. In response to the external service registration request, the orchestrator service 136 can configure a replication pipeline 236 that uses a messaging platform 109 to provide the specified event data 200 to the network service 107. Since the network service 107 can come from an external network location that can be untrusted, the request can be authenticated using tenant-specific and entity-specific authentication data that matches the tenant identifiers 203 and entity identifiers 206 specified. The authentication data can include certificates, username and password, tokens, and so on. The orchestrator service 136 can authorize the external service registration request and configure a replication pipeline 236. The orchestrator service 136 can also configure a messaging platform 109 as part of replication pipeline 236 configuration.

The orchestrator service 136 can receive the event data 200 as a message or another type of data transmission. In some examples a publication subscription mechanism can provide a data-source-specific subscription to all event data 200 for the management data source service 134. Generally, the orchestrator service 136 can subscribe or receive all event data 200 for all management data source services 134. The orchestrator service 136 can then identify a subset of the event data 200 messages that include data that matches both the tenant identifiers 203 and entity identifiers 206 specified for each replication pipeline 236 and replicate that event data by copying, publishing, transmitting, or otherwise providing the subset of the event data 200 to the matching replication pipelines 236.

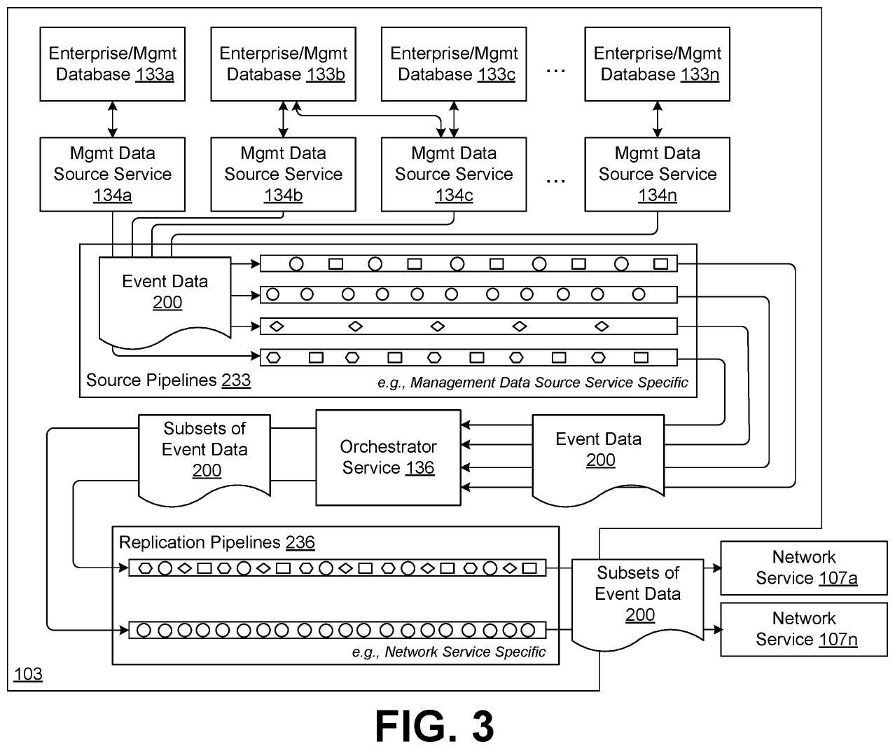

FIG. 3 shows an example of how the components of the networked environment 100 can interact to provide an extensible architecture for replication of event data generated by management data source services 134. Generally, this example provides an example of how the orchestrator service 136 uses event pipelines 138, including source pipelines 233 and replication pipelines 236, to aggregate event data from multiple management data source services 134 and replicate the event data 200 for consumption by network services 107.

Multiple management data source services 134a, 134b, 134c . . . 134n (collectively, the management data source services 134) are shown in association with multiple management databases 133a, 133b, 133c . . . 133n (collectively, the management databases 133). In this example, the management database 133a stores data for management data source service 134a. The management database 133b stores data for management data source service 134b, as well as management data source service 134c. The management database 133c stores data for management data source service 134c. The management database 133n stores data for management data source service 134n. In some examples, certain ones of the management data source services 134 and certain ones of the management databases 133 can be exclusive to a particular tenant and tenant identifier 203. However, each of the management data source services 134 and each of the management databases 133 can include event data corresponding to any number of different entity identifiers 206 and any number of tenant identifiers 203.

The orchestrator service 136 can generate and maintain a source-specific source pipeline 233 for each one of the management data source services 134. In this example, the source pipelines 233 include shapes that can represent event data 200 corresponding to certain entity identifiers 206 (and/or tenant identifiers 203). The orchestrator service 136 can receive the event data 200 through the source pipelines 233, and replicate the event data 200 into multiple replication pipelines 236. Each of the source pipelines 233 and the replication pipelines 236 can use a publication subscription mechanism or another data transmission or messaging mechanism used by a messaging platform 109. The orchestrator service 136 can identify a subset of the event data 200 that matches a set of entity identifiers 206 and tenant identifiers 203 registered in association with a replication pipeline 236. The orchestrator service 136 can replicate the subset of the event data 200 and transmit, publish, or copy it to a replication pipeline 236 that provides it to a network service 107.

The network service 107a can be registered in association with one of the replication pipelines 236. The network service 107a can receive a subset of the event data 200 that matches a set of entity identifiers 206 and tenant identifiers 203 registered in association with its replication pipeline 236. The network service 107n can be registered in association with a different one of the replication pipelines 236, and can receive a different subset of the event data 200.

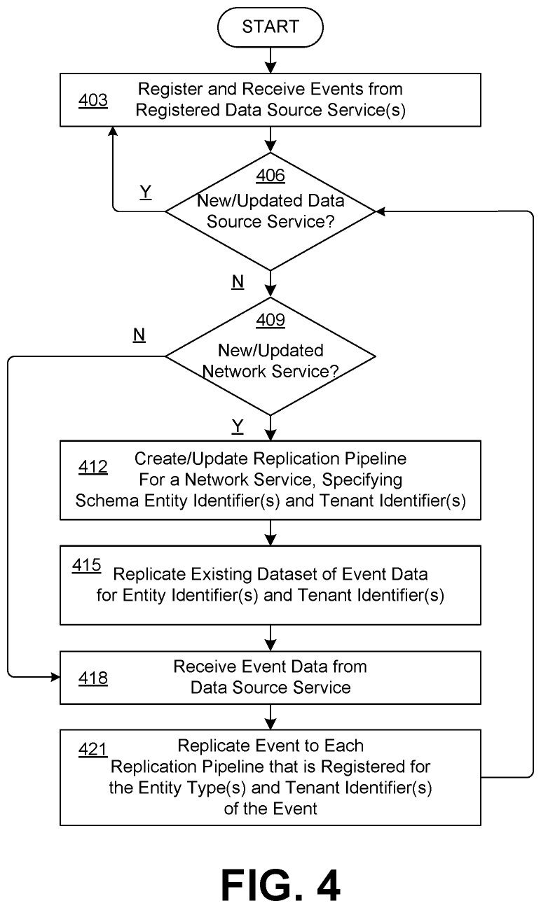

FIG. 4 shows a flowchart performed by components of the networked environment 100. The flowchart illustrates how the components of the networked environment 100 provide an extensible architecture for replication of event data. Generally, this example provides an example of the operation of the orchestrator service 136 in association with other components of the extensible architecture for replication of event data 200. While referred to as the orchestrator service 136, the actions performed by the orchestrator service 136 can also be performed by one or many components of the management service 120. Other components of the networked environment 100 can perform certain aspects of the steps as can be understood.

In step 403, the orchestrator service 136 can register and receive event data 200 from registered management data source services 134 that comprise functionalities of the management service 120. Each of the management data source services 134 can monitor, store, and access data from one or more management databases 133 of the management service 120. Each of the management data source services 134 can provide event data 200 that corresponds to changes in associated management databases 133. The orchestrator service 136 can receive event data 200 from the registered management data source services 134 through their corresponding source pipelines 233.

In step 406, the orchestrator service 136 can identify whether there is a new or updated management data source service 134. The orchestrator service 136 can receive a source registration request from each of the management data source services 134, and can create corresponding source pipelines 233. In some examples, the source registration request can specify one or more entity identifiers 206 and tenant identifiers 203 for which the management data source service 134 provides event data 200. An administrative user can provide information that defines a source registration request by manipulating user interface elements in a console user interface. The information in the request can include communication information and/or network addresses for the management data source service 134. In some examples, the orchestrator service 136 can configure a source pipeline 233 and return communication information that a management data source service 134 to publish or otherwise transmit event data 200.

The communication information and network addresses can reference internal network information and addresses in the private WAN or LAN of the management computing environment 103. In either case, the orchestrator service 136 can identify that there is a new or updated management data source service 134 based on the source registration requests. The process can move to step 403 to register and receive event data 200 from the identified management data source services 134. Otherwise, the process can move to step 409.

In step 409, the orchestrator service 136 can identify whether there is a new or updated network service 107. The orchestrator service 136 can receive a network service registration request from a network service 107, and can create a corresponding replication pipeline 236. An administrative user can provide information that defines a network service registration request by manipulating user interface elements in a console user interface. The information in the request can include communication information and/or network addresses for the network service 107, one or more tenant identifier 203 and corresponding authentication information, as well as one or more entity identifier 206 and corresponding authentication information. If there is a new or updated network service 107, then the process can move to steps 412 and 415. Otherwise, the process can move to step 418.

In step 412, the orchestrator service 136 can create a replication pipeline 236 based on the information in a network service registration request. The orchestrator service 136 can register a replication pipeline 236 in association with the specified tenant identifiers 203 and entity identifiers 206 in the network service registration request. The orchestrator service 136 can also configure the replication pipeline 236 to provide the relevant event data 200 to the network service 107. The replication pipeline 236 can use a messaging platform 109 to publish, push, transmit to a network location, or otherwise provide the event data 200 to a network service 107. In some examples, the orchestrator service 136 can also return access information that a network service 107 can use to access, authenticate with, and receive event data 200 from the replication pipeline 236.

In step 415, the orchestrator service 136 can replicate an existing dataset of event data 200 corresponding to the specified tenant identifiers 203 and entity identifiers 206 for the newly registered network service 107. This can include accessing or requesting all event data corresponding to the specified tenant identifiers 203 and entity identifiers 206. In some examples, the orchestrator service 136 can transmit snapshot requests to all management data source services 134, or a subset that provides event data 200 corresponding to the specified tenant identifiers 203 and entity identifiers 206. In either case, the orchestrator service 136 can provide the snapshots of the existing dataset, filtered or limited to the specified tenant identifiers 203 and entity identifiers 206. This can provide the newly registered network service 107 a starting point for the current set of event data 200.

In step 418, the orchestrator service 136 can receive event data 200 from one or more management data source services 134. Generally, the orchestrator service 136 can subscribe or receive all event data 200 for all management data source services 134. The event data 200 can correspond to event data 200 update messages generated in response to updates to data in the management databases 133. The event data 200 can specify a tenant identifier 203, an entity identifier 206, an event type 209, a record identifier 212, and attribute data 215. The orchestrator service 136 can receive the event data 200 as a published message according to a publication subscription mechanism or another type of data transmission.

In step 421, the orchestrator service 136 can replicate events data 200 to the replication pipelines 236. The orchestrator service 136 can identify a subset of the event data 200 messages that includes data that matches both the tenant identifiers 203 and entity identifiers 206 specified for each replication pipeline 236 and replicate that message or its data by copying, publishing, transmitting, or otherwise providing the subset of the event data 200 to the matching replication pipelines 236.

The flowchart(s) and sequence diagram(s) show examples of the functions and operation of the components described herein. The components described herein can be embodied in hardware, software, or a combination of hardware and software. If embodied in software, each element can represent a module or group of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or several interconnected circuits that implement the specified logical function(s).

The management computing environment 103 can include at least one processing circuit. Such a processing circuit can include, for example, one or more processors and one or more storage or memory devices that are coupled to a local interface. The local interface can include, for example, a data bus with an accompanying address/control bus or any other suitable bus structure. Similarly, the client devices 106 can each include at least one processing circuit. Such a processing circuit can include, for example, one or more processors and one or more storage or memory devices that are coupled to a local interface.

The storage or memory devices can store data or components that are executable by the processors of the processing circuit. For example, the management service 120 and/or other components can be stored in one or more storage devices and be executable by one or more processors in the networked environment 100. Similarly, the agents, services, applications and/or other components described herein can be stored in one or more storage devices and be executable by one or more processors in the client device 106.

The management service 120 and/or other components described herein can be embodied in the form of hardware, software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Further, any logic or applications described herein, including the management service 120 and/or other components can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices. Additionally, terms such as “application,” “service,” “system,” “engine,” “module,” and so on can be used interchangeably and are not intended to be limiting.

The above-described examples of the present disclosure are merely possible examples of implementations set forth for a clear understanding of the principles of the disclosure. Many variations and modifications can be made without departing substantially from the spirit and principles of the disclosure. All such modifications and variations are intended to be included herein within the scope of this disclosure and protected by the following claims.

Therefore, the following is claimed:

1. A method, comprising:
identifying, by an orchestrator service of a management computing environment, a plurality of management data source services, wherein a particular management data source service maintains a corresponding database;
generating, by the orchestrator service, a plurality of network-service-specific replication pipelines for a corresponding plurality of network services, wherein a particular replication pipeline is registered in association with at least one tenant identifier and at least one entity identifier;
receiving, by the orchestrator service, a plurality of database update messages collectively comprising event data for a plurality of entity identifiers and a plurality of tenant identifiers; and
replicating, by the orchestrator service, a subset of the event data into the particular replication pipeline, wherein a particular network service receives the subset of the event data through the particular replication pipeline, and the replicated subset of the event data is identified using the at least one tenant identifier and the at least one entity identifier registered for the particular replication pipeline.

2. The method according to claim 1, wherein the corresponding plurality of network services are external to the management computing environment.

3. The method according to claim 1, further comprising:
generating, by the orchestrator service, a plurality of source-service-specific replication pipelines corresponding to the plurality of management data source services.

4. The method according to claim 3, further comprising:
receiving, by the orchestrator service, a plurality of source registration requests for the plurality of management data source services, wherein the source-service-specific replication pipelines are generated in response to the source registration requests.

5. The method according to claim 1, wherein the plurality of management data source services are internal to the management computing environment.

6. The method according to claim 1, wherein the particular replication pipeline uses a messaging platform to provide the subset of the event data to the particular network service.

7. The method according to claim 1, wherein the particular management data source service transmits a subset of the plurality of database update messages based at least in part on changes to data in the corresponding database maintained by the particular management data source service.

8. A non-transitory computer-readable medium embodying instructions executable by at least one computing device, wherein the instructions, when executed, cause the at least one computing device to at least:
identify, by an orchestrator service of a management computing environment, a plurality of management data source services, wherein a particular management data source service maintains a corresponding database;
generate, by the orchestrator service, a plurality of network-service-specific replication pipelines for a corresponding plurality of network services, wherein a particular replication pipeline is registered in association with at least one tenant identifier and at least one entity identifier;
receive, by the orchestrator service, a plurality of database update messages collectively comprising event data for a plurality of entity identifiers and a plurality of tenant identifiers; and
replicate, by the orchestrator service, a subset of the event data into the particular replication pipeline, wherein a particular network service receives the subset of the event data through the particular replication pipeline, and the replicated subset of the event data is identified using the at least one tenant identifier and the at least one entity identifier registered for the particular replication pipeline.

9. The non-transitory computer-readable medium according to claim 8, wherein the corresponding plurality of network services are external to the management computing environment.

10. The non-transitory computer-readable medium according to claim 8, wherein the instructions, when executed, cause the at least one computing device to at least:
generate, by the orchestrator service, a plurality of source-service-specific replication pipelines corresponding to the plurality of management data source services.

11. The non-transitory computer-readable medium according to claim 10, wherein the instructions, when executed, cause the at least one computing device to at least:
receive, by the orchestrator service, a plurality of source registration requests for the plurality of management data source services, wherein the source-service-specific replication pipelines are generated in response to the source registration requests.

12. The non-transitory computer-readable medium according to claim 8, wherein the plurality of management data source services are internal to the management computing environment.

13. The non-transitory computer-readable medium according to claim 8, wherein the particular replication pipeline uses a messaging platform to provide the subset of the event data to the particular network service.

14. The non-transitory computer-readable medium according to claim 8, wherein the particular management data source service transmits a subset of the plurality of database update messages based at least in part on changes to data in the corresponding database maintained by the particular management data source service.

15. A system, comprising:
at least one computing device; and
instructions accessible by the at least one computing device, wherein the instructions, when executed, cause the at least one computing device to at least:
identify, by an orchestrator service of a management computing environment, a plurality of management data source services, wherein a particular management data source service maintains a corresponding database;
generate, by the orchestrator service, a plurality of network-service-specific replication pipelines for a corresponding plurality of network services, wherein a particular replication pipeline is registered in association with at least one tenant identifier and at least one entity identifier;
receive, by the orchestrator service, a plurality of database update messages collectively comprising event data for a plurality of entity identifiers and a plurality of tenant identifiers; and
replicate, by the orchestrator service, a subset of the event data into the particular replication pipeline, wherein a particular network service receives the subset of the event data through the particular replication pipeline, and the replicated subset of the event data is identified using the at least one tenant identifier and the at least one entity identifier registered for the particular replication pipeline.

16. The system of claim 15, wherein the corresponding plurality of network services are external to the management computing environment.

17. The system of claim 15, wherein the instructions, when executed, cause the at least one computing device to at least:
generate, by the orchestrator service, a plurality of source-service-specific replication pipelines corresponding to the plurality of management data source services.

18. The system of claim 15, wherein the plurality of management data source services are internal to the management computing environment.

19. The system of claim 15, wherein the particular replication pipeline uses a messaging platform to provide the subset of the event data to the particular network service.

20. The system of claim 15, wherein the particular management data source service transmits a subset of the plurality of database update messages based at least in part on changes to data in the corresponding database maintained by the particular management data source service.
